(19) United States
(12) Patent Application Publication
(10) Pub. No.: US 2024/0045123 A1
(43) Pub. Date: Feb. 8, 2024

(54) LENS AND CAMERA MODULE

(71) Applicant: AAC Optics (Nanning) Co., Ltd., Nanning City (CN)

(72) Inventor: Eero Sakari Paivansalo, Tampere (FI)

(21) Appl. No.: 17/879,750

(22) Filed: Aug. 2, 2022

(51) Int. Cl. G02B 5/20

(52) U.S. Cl. CPC G02B 5/208

(57) ABSTRACT

Provided is a lens and a camera module. The lens includes an infrared cut-off filter and a first lens, and the infrared cut-off filter and the first lens are connected to each other by laser bonding. The components of the lens are all connected by laser bonding. Compared with the method of glue bonding, this connection method makes the connection between the components more secure, and will not affect the connection performance due to differences in temperature, humidity, and materials, thereby obtaining smaller assembly tolerance and thus beneficial to improve optical yield and performance of the lens. The need for a large number of process steps such as curing for glue bonding is omitted, thereby facilitating automation of the assembly and production process. In addition, there will be no glue pollution to the components, the connection method is environmentally friendly.

### TECHNICAL FIELD

The present disclosure relates to the technical field of electronic devices, and in particular, to a lens and camera module.

### BACKGROUND

A camera is a video input device. The camera generally includes components such as a lens, a spacer, an infrared cut-off filter, a sensor cover, and a housing. These components are usually connected together by glue. In addition, the lens generally includes multiple layers of lenses, and the lenses are connected together by glue. The method of connecting with glue has disadvantages such as complicated operation process, unfastened bonding, large manufacturing and assembly tolerances, not environmental protective, and adverse effects on laser cutting.

### SUMMARY

The present disclosure provides a lens and a camera module to solve the problems in current connection method between camera lenses or between camera components of complicated operation processes, unfastened bonding, large manufacturing and assembly tolerances, not environmental protective, and adverse effects on laser cutting.

According to a first aspect of the present disclosure, a lens is provided, including an infrared cut-off filter and a first lens, and the infrared cut-off filter and the first lens are connected by laser bonding.

As an improvement, the lens further includes a second lens connected to a side of the first lens facing away from the infrared cut-off filter by laser bonding.

As an improvement, the infrared cut-off filter has a first laser bonding surface, the first lens has a second laser bonding surface and a third laser bonding surface, the second lens has a fourth laser bonding surface. The first laser bonding surface and the second laser bonding surface are connected by laser bonding, and the third laser bonding surface and the fourth laser bonding surface are connected by laser bonding. The first laser bonding surface, the second laser bonding surface, the third laser bonding surface and the fourth laser bonding surface are all flat surfaces.

As an improvement, the lens further includes a third lens and an aperture, wherein the infrared cut-off filter, the first lens, the aperture and the third lens are connected by laser bonding.

As an improvement, the infrared cut-off filter has a first laser bonding surface, the first lens has a second laser bonding surface and a third laser bonding surface, the third lens has a fifth laser bonding surface, the aperture has a sixth laser bonding surface and a seventh laser bonding surface. The first laser bonding surface and the second laser bonding surface are connected by laser bonding, the third laser bonding surface and the sixth laser bonding surface are connected by laser bonding, and the seventh laser bonding surface and the fifth laser bonding surface are connected by laser bonding. The first laser bonding surface, the second laser bonding surface, the third laser bonding surface, the fifth laser bonding surface, the sixth laser bonding surface and the seventh laser bonding surface are all flat surfaces.

As an improvement, a laser bonding region has a shape of discontinuous dots or line pattern or a continuous surface.

According to a second aspect of the present disclosure, a camera module is provided, including the above-mentioned lens and a housing, the housing is connected to a side of the infrared cut-off filter facing away from the first lens by laser bonding, and the housing is provided with a central through hole along its length direction.

As an improvement, the camera module further includes a substrate connected to an end of the housing facing away from the infrared cut-off filter by laser bonding, and one end of the central through hole is sealed by the substrate.

As an improvement, the camera module further includes an image sensor connected to a side of the substrate facing toward the central through hole.

The beneficial effects of the present disclosure are as follows:

The components of the lens of the present disclosure are all connected by laser bonding. Compared with the method of glue bonding, this connection method makes the connection between the components more secure, and will not affect the connection performance due to differences in temperature, humidity, and materials, thereby obtaining smaller assembly tolerance and thus beneficial to improve optical yield and performance of the lens. The need for a large number of process steps such as curing for glue bonding is omitted, thereby facilitating automation of the assembly and production process. In addition, there will be no glue pollution to the components, the connection method is environmentally friendly. Moreover, when the camera module is laser cut, it will not be affected by glue and other substances, so that the laser cutting is smoother.

The components of a camera module of the present disclosure are connected by laser bonding. Compared with the method of glue bonding, connection method makes connection between components of the camera module stronger, and the connection performance will not be affected by differences in temperature, humidity and materials, thereby obtaining smaller manufacturing and assembly tolerance and superior dust and humidity proof functions by preventing entrance of dust through the central through hole of the housing, and thus is beneficial to improve the optical yield and performance of the lens module. The need for a large number of process steps such as curing for glue bonding is omitted, thereby facilitating automation of the assembly and production process. In addition, there will be no glue pollution to the components, the connection method is environmentally friendly. Moreover, when the camera module is laser cut, it will not be affected by glue and other substances, so that the laser cutting is smoother, and thus facilitates manufacturing a smaller camera module.

It should be understood that the above general description and the following detailed description are only exemplary and shall not be construed as limiting the present disclosure.

### BRIEF DESCRIPTION OF DRAWINGS

FIG. 1 is a schematic diagram of a first lens structure provided by the present disclosure;

FIG. 2 is a sectional view taken along line A-A in FIG. 1;

FIG. 3 is a schematic diagram of a second lens structure provided by the present disclosure;

FIG. 4 is a sectional view taken along line B-B in FIG. 3;

FIG. 5 is a schematic diagram of a third lens structure provided by the present disclosure;

FIG. 6 is a sectional view taken along line C-C in FIG. 5;

FIG. 7 is a schematic structural diagram of a camera module provided by the present disclosure;

FIG. 8 is a sectional view taken along line D-D in FIG. 7.

### REFERENCE SIGNS

1—Infrared cut-off filter;
   11—First laser bonding surface;
2—First lens;
   21—Second laser bonding surface;
   22—Third laser bonding surface;
3—Second lens;
   31—Fourth laser bonding surface;
4—Third lens;
   41—Fifth laser bonding surface;
5— Aperture;
   51—Sixth laser bonding surface;
   52—Seventh laser bonding surface;
6—Laser bonding area;
100—Lens;
101—Shell;
   1010—Central through hole;
102—Substrate;
103—Image sensor.

The drawings here are incorporated into the specification and constitute a part of the specification, which show embodiments of the present disclosure, and are used together with the specification to explain the principle of the present disclosure.

### DESCRIPTION OF EMBODIMENTS

In order to better understand the technical solutions of the present disclosure, the following describes the embodiments of the present disclosure in detail with reference to the accompanying drawings.

It should be clear that the described embodiments are only a part of the embodiments of the present disclosure, rather than all of the embodiments. Based on the embodiments in the present disclosure, all other embodiments obtained by those of ordinary skill in the art without creative work shall fall within the protection scope of the present disclosure.

The terms used in the embodiments of the present disclosure are only for the purpose of describing specific embodiments, and are not intended to limit the present disclosure. The singular forms of “a”, “the” and “said” used in embodiments of the present disclosure and the appended claims are also intended to include plural forms, unless the context clearly indicates other meanings.

It should be understood that the term “and/or” used in the present disclosure is only an association relationship describing associated objects, which means that there can be three relationships, for example, A and/or B can mean that A alone exists, and A and B exist at the same time, and B alone exists. In addition, the character “/” in the present disclosure generally indicates that the associated objects before and after “/” are in an “or” relationship.

It should be noted that the terms “above”, “below”, “left” and “right” described in embodiments of the present disclosure are described from the perspective shown in the drawings, and should not be construed as limiting the present disclosure. In addition, in the context, it should also be understood that when it is mentioned that an element is connected “above” or “below” another element, it may be directly connected to another element “above” or “below”, but also indirectly connected “above” or “below” another element through an intermediate element.

Embodiments of the present disclosure provide a lens, which may be, but is not limited to, a camera lens and a remote camera lens, and the lens may be applied to a camera module.

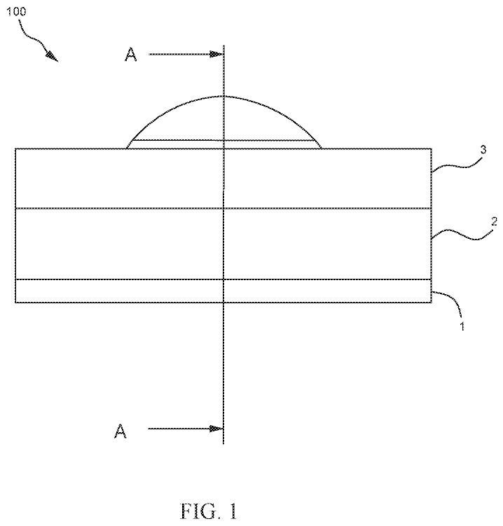

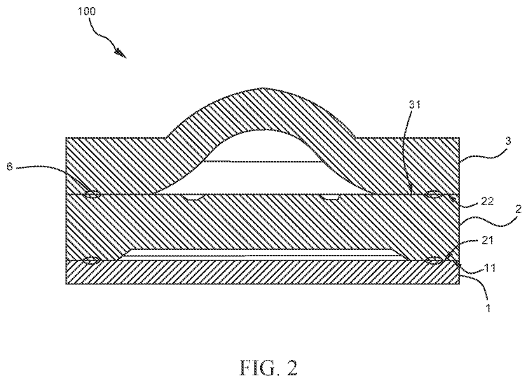

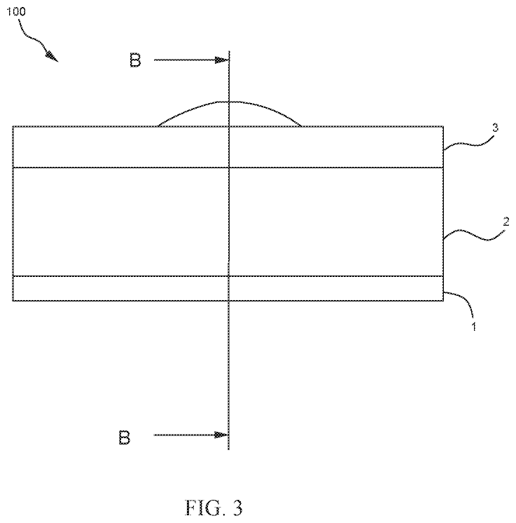

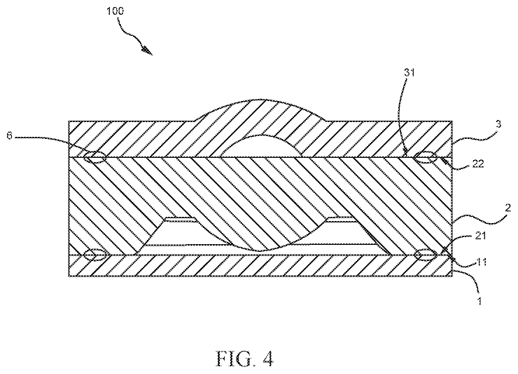

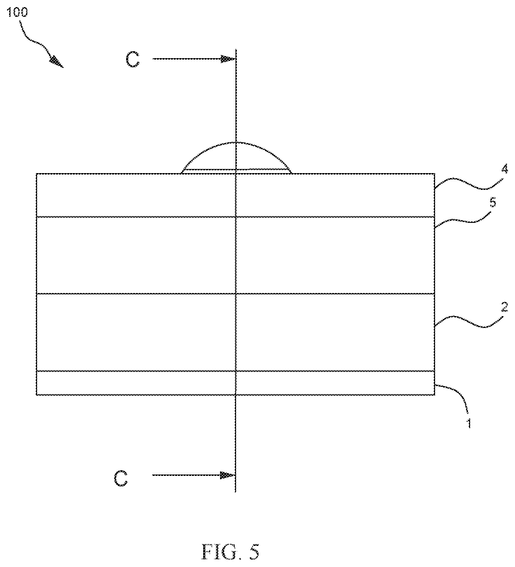

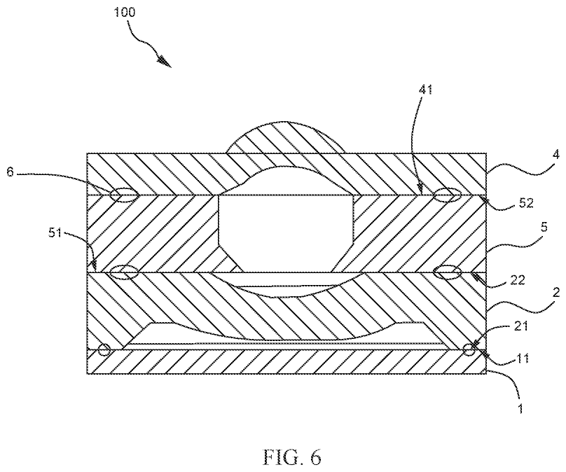

Embodiments of the present disclosure provides a lens as shown in FIG. 1-FIG. 6. FIG. 1 and FIG. 2 illustrate main (wide-angle) camera lens, FIG. 3 and FIG. 4 illustrate ultra-wide (UW) camera lens, FIG. 5 and FIG. 6 illustrate remote camera lens. The lens 100 includes an infrared cut-off filter 1 and a first lens 2, and the infrared cut-off filter 1 and the first lens 2 are connected to each other by laser bonding. Each of the infrared cut-off filter 1 and the first lens 2 includes a glass wafer.

The first lens 2 is an optical element made of a transparent material having a surface as a part of a sphere. The first lens 2 includes a glass wafer, and the first lens 2 is a concave lens, which has the function of diverging light. The parallel light is deflected by the concave lens, and the light diverges and becomes a divergent light.

The infrared cut-off filter 1 has a shielding effect on infrared rays, so that the viewing angle of the lens 100 is wider.

The principle of laser bonding is to use the thermal effect of the interaction between the laser and the substance to realize the local heating and bonding of a microsystem device. The laser has excellent transmission and focusing characteristics, and the energy can be concentrated at one point after passing through the focusing lens. Therefore, the laser can make the temperature of the irradiated area rise sharply within a short time, so as to achieve the purpose of local bonding in a selected area. Laser bonding requires a beam to be focused on an interface of a bonding sheet, which requires that one of the bonding sheets participating in the bonding can be penetrated by the laser, and the other bonding sheet should have a good absorption rate to laser. Typical laser bonding materials are silicon and glass. The advantages of the laser bonding method are non-contact local heating, suitable for complex shapes, and strong flexibility. Different wavelengths of laser can be adopted.

The infrared cut-off filter 1 and the first lens 2 of the lens 100 in this embodiment are connected by laser bonding. Compared with the method of glue bonding, this connection method makes the connection between the infrared cut-off filter 1 and the first lens 2 more secure, and will not affect the connection performance due to differences in temperature, humidity and materials, thereby obtaining smaller assembly tolerance and thus beneficial to improve optical yield and performance of the lens 100. The need for a large number of process steps such as curing for glue bonding is omitted, thereby facilitating automation of the assembly and production process. In addition, there will be no glue pollution to the components, the connection method is environmentally friendly. Moreover, when the lens 100 is laser cut, it will not be affected by glue and other substances, so that the laser cutting is smoother.

In an embodiment, as shown in FIGS. 1-4, the lens further includes a second lens 3, and the second lens 3 is connected to the side of the first lens 2 away from the infrared cut-off filter 1 by laser bonding. The second lens 3 includes a glass wafer.

The second lens 3 is an optical element made of a transparent material having a surface as a part of a sphere. The second lens 3 includes a glass wafer, and the second lens 3 is a convex lens that has a function of condensing light.

In this embodiment, during laser bonding, the laser acts on the glass wafers of the second lens 3 and the first lens 2, and the laser can sharply increase the temperature of the irradiated glass wafer area within a short time. The purpose of local bonding is to realize the connection between the second lens 3 and the first lens 2. Compared with the method of glue bonding, this connection method makes the connection between the second lens 3 and the first lens 2 more secure, and will not affect the connection performance due to differences in temperature, humidity, and materials, thereby obtaining smaller assembly tolerance and thus beneficial to improve optical yield and performance of the lens 100. The need for a large number of process steps such as curing for glue bonding is omitted, thereby facilitating automation of the assembly and production process. In addition, there will be no glue pollution to the components, the connection method is environmentally friendly. Moreover, when the lens 100 is laser cut, it will not be affected by glue and other substances, so that the laser cutting is smoother.

In an embodiment, as shown in FIGS. 2 and 4, the infrared cut-off filter 1 has a first laser bonding surface 11. The first lens 2 has a second laser bonding surface 21 and a third laser bonding surface 22. The second lens 3 has a fourth laser bonding surface 31. The first laser bonding surface 11 and the second laser bonding surface 21 are connected by laser bonding. The third laser bonding surface 22 and the fourth laser bonding surface 31 are connected by laser bonding.

The first laser bonding surface 11, the second laser bonding surface 21, the third laser bonding surface 22, and the fourth laser bonding surface 31 are all flat surfaces.

The laser bonding surface refers to the surface on which the laser directly acts. The laser is irradiated on the laser bonding surface to increase the temperature of the area sharply, so as to achieve the purpose of bonding two adjacent components.

By defining that the first laser bonding surface 11, the second laser bonding surface 21, the third laser bonding surface 22, and the fourth laser bonding surface 31 are all flat surfaces, the laser bonding is easier to be conducted on planes or smooth surfaces in close contact with each other, so that the connection between the infrared cut-off filter 1, the first lens 2 and the second lens 3 can be tighter, thereby reducing manufacturing and assembly tolerances.

In an embodiment, as shown in FIGS. 5 and 6, the lens further includes a third lens 4 and an aperture 5. The infrared cut-off filter 1, the first lens 2, the aperture 5, and the third lens 4 are connected by laser bonding.

The aperture 5 is a component used to control the amount of light passing through the lens 100, and it also includes a glass wafer.

The infrared cut-off filter 1, the first lens 2, the aperture 5 and the third lens 4 are all connected by laser bonding. Compared with the method of glue bonding, this connection method makes connection between components of the lens 100 stronger, and the connection performance will not be affected by differences in temperature, humidity and materials, thereby obtaining smaller manufacturing and assembly tolerance and thus is beneficial to improve the optical yield and performance of the lens 100. The need for a large number of process steps such as curing for glue bonding is omitted, thereby facilitating automation of the assembly and production process. In addition, there will be no glue pollution to the components, the connection method is environmentally friendly. Moreover, when the lens 100 is laser cut, it will not be affected by glue and other substances, so that the laser cutting is smoother.

In an embodiment, as shown in FIG. 6, the infrared cut-off filter 1 has a first laser bonding surface 11. The first lens 2 has a second laser bonding surface 21 and a third laser bonding surface 22. The three lens 4 has a fifth laser bonding surface 41. The aperture 5 has a sixth laser bonding surface 51 and a seventh laser bonding surface 52. The first laser bonding surface 11 and the second laser bonding surface 21 are connected by laser bonding. The third laser bonding surface 22 and the sixth laser bonding surface 51 are connected by laser bonding. The seventh laser bonding surface 52 and the fifth laser bonding surface 41 are connected by laser bonding.

The first laser bonding surface 11, the second laser bonding surface 21, the third laser bonding surface 22, the fifth laser bonding surface 41, the sixth laser bonding surface 51, and the seventh laser bonding surface 52 are all flat surfaces.

The laser bonding surface refers to the surface on which the laser directly acts. The laser is irradiated on the laser bonding surface to increase the temperature of the area sharply, so as to achieve the purpose of bonding two adjacent components.

By defining the first laser bonding surface 11, the second laser bonding surface 21, the third laser bonding surface 22, the fifth laser bonding surface 41, the sixth laser bonding surface 51, and the seventh laser bonding surface 52 all as flat surfaces, the laser bonding is easier to be conducted on planes or smooth surfaces in close contact with each other, so that the connection between the infrared cut-off filter 1, the first lens 2, the aperture 5 and the third lens 4 can be tighter, thereby reducing manufacturing and assembly tolerances.

According to different application scenarios, in an embodiment, the laser bonding area 6 of the laser bonding is in the shape of discontinuous points or a continuous surface.

The formation of the discontinuous dot-shaped or line pattern laser bonding area 6 is formed by irradiating laser light along the spaced points on the laser bonding surface. The continuous laser bonding area 6 is formed by continuous laser irradiation along a set surface area on the laser bonding surface.

An embodiment of the present disclosure also provides a camera module, which can realize the conversion between optical signals and electrical signals, record and store image information, so as to realize the functions of photographing and video recording. It can be applied to, but not limited to, mobile devices such as mobile phones and tablet computers.

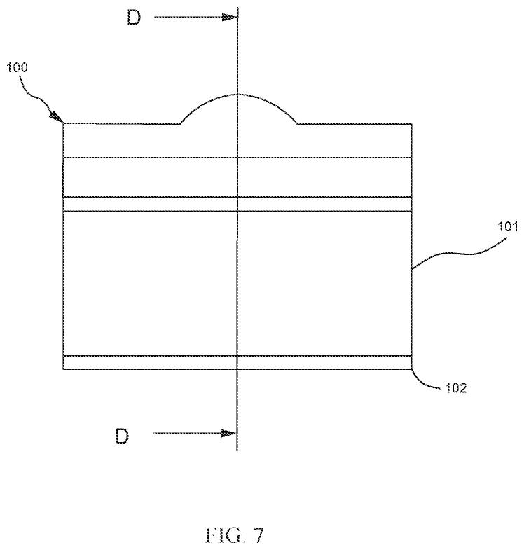

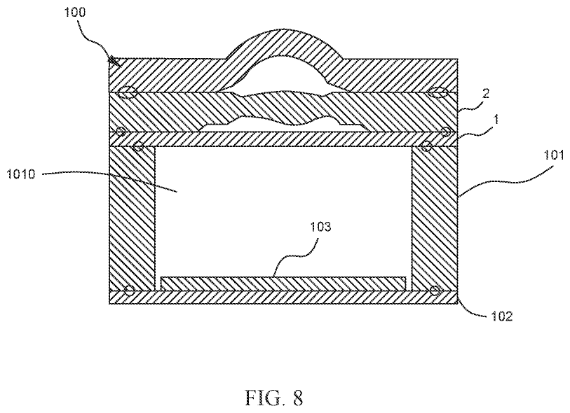

As shown in FIGS. 7 and 8, the camera module includes the lens 100 of the present disclosure and a housing 101, and the housing 101 and the side of the infrared cut-off filter 1 facing away from the first lens 2 are connected by laser bonding. The housing 101 is provided with a central through hole 1010 along a length direction.

By connecting the lens 100 of the camera module and the housing 101 by laser bonding, compared with the method of glue bonding, this connection method makes connection between components of the camera module stronger, and the connection performance will not be affected by differences in temperature, humidity and materials, thereby obtaining smaller manufacturing and assembly tolerance and superior dust and humidity proof functions by preventing entrance of dust through the central through hole 1010 of the housing 101, and thus is beneficial to improve the optical yield and performance of the lens module. The need for a large number of process steps such as curing for glue bonding is omitted, thereby facilitating automation of the assembly and production process. In addition, there will be no glue pollution to the components, the connection method is environmentally friendly. Moreover, when the camera module is laser cut, it will not be affected by glue and other substances, so that the laser cutting is smoother, and thus facilitates manufacturing a smaller camera module.

In an embodiment, the camera module further includes a substrate 102. The substrate 102 is connected to an end of the housing 101 facing away from the infrared cut-off filter 1 by laser bonding. One end of the central through hole 1010 is sealed by the substrate 102. The substrate 102 is for example a glass substrate, which is a supporting structure for electronic components and circuits.

By connecting the substrate 102 of the camera module and the housing 101 by laser bonding, compared with the method of glue bonding, this connection method makes connection between components of the camera module stronger, and the connection performance will not be affected by differences in temperature, humidity and materials, thereby obtaining smaller manufacturing and assembly tolerance and superior dust and humidity proof functions by preventing entrance of dust through the central through hole 1010 of the housing 101.

In an embodiment, the camera module further includes an image sensor 103, and the image sensor 103 is connected to a side of the substrate 102 facing the central through hole 1010.

The image sensor 103 utilizes the photoelectric conversion function of a photoelectric device to convert the light image on the photosensitive surface into an electrical signal proportional to the light image.

The image sensor 103 is connected to the side of the substrate 102 facing the central through hole 1010, and the infrared cut-off filter 1, the substrate 102 and the housing 101 are all connected by laser bonding. This connection method makes connection between the infrared cut-off filter 1, the substrate 102 and the housing 101 stronger, thereby obtaining smaller manufacturing and assembly tolerance and superior dust and humidity proof functions of the image sensor 103 by preventing entrance of dust through the central through hole 1010 of the housing 101.

The foregoing descriptions are only preferred embodiments of the present disclosure, and are not intended to limit the present disclosure. For those skilled in the art, the present disclosure can have various modifications and changes. Any modification, equivalent replacement, improvement, etc. made within the spirit and principle of the present disclosure shall be included in the protection scope of the present disclosure.

What is claimed is:

1. A lens comprising an infrared cut-off filter and a first lens, wherein the infrared cut-off filter and the first lens are connected to each other by laser bonding.

2. The lens according to claim 1, further comprising a second lens connected to a side of the first lens facing away from the infrared cut-off filter by laser bonding.

3. The lens according to claim 2, wherein the infrared cut-off filter has a first laser bonding surface, the first lens has a second laser bonding surface and a third laser bonding surface, the second lens has a fourth laser bonding surface;
the first laser bonding surface and the second laser bonding surface are connected by laser bonding, and the third laser bonding surface and the fourth laser bonding surface are connected by laser bonding; and
the first laser bonding surface, the second laser bonding surface, the third laser bonding surface and the fourth laser bonding surface are all flat surfaces.

4. The lens according to claim 1, further comprising a third lens and an aperture, wherein the infrared cut-off filter, the first lens, the aperture and the third lens are connected by laser bonding.

5. The lens according to claim 4, wherein the infrared cut-off filter has a first laser bonding surface, the first lens has a second laser bonding surface and a third laser bonding surface, the third lens has a fifth laser bonding surface, the aperture has a sixth laser bonding surface and a seventh laser bonding surface;
the first laser bonding surface and the second laser bonding surface are connected by laser bonding, the third laser bonding surface and the sixth laser bonding surface are connected by laser bonding, and the seventh laser bonding surface and the fifth laser bonding surface are connected by laser bonding; and
the first laser bonding surface, the second laser bonding surface, the third laser bonding surface, the fifth laser bonding surface, the sixth laser bonding surface and the seventh laser bonding surface are all flat surfaces.

6. The lens according to claim 1, wherein a laser bonding region has a shape of discontinuous dots or line pattern or a continuous surface.

7. A camera module, comprising a lens and a housing,
wherein the lens comprises an infrared cut-off filter and a first lens, and the infrared cut-off filter and the first lens are connected to each other by laser bonding; and
the housing is connected to a side of the infrared cut-off filter facing away from the first lens by laser bonding, and the housing is provided with a central through hole along its length direction.

8. The camera module according to claim 7, further comprising a substrate connected to an end of the housing facing away from the infrared cut-off filter by laser bonding, and one end of the central through hole is sealed by the substrate.

9. The camera module according to claim 8, further comprising an image sensor connected to a side of the substrate facing toward the central through hole.
